(19) United States
(12) Patent Application Publication
(10) Pub. No.: US 2023/0269704 A1
(43) Pub. Date: Aug. 24, 2023

(54) METHOD AND APPARATUS FOR DETERMINING RESOURCE AVAILABILITY

(71) Applicant: LENOVO (BEIJING) LIMITED, Beijing (CN)

(72) Inventors: Zhennian SUN, Beijing (CN); Xiaodong YU, Beijing (CN); Haipeng LEI, Beijing (CN); Xin GUO, Beijing (CN)

(21) Appl. No.: 18/040,065

(22) PCT Filed: Jul. 31, 2020
(86) PCT No.: PCT/CN2020/106250

§ 371 Date: Jan. 31, 2023

(51) Int. Cl. H04W 72/02; H04W 28/26; H04W 72/0446

(52) U.S. Cl. CPC H04W 72/02; H04W 28/26; H04W 72/0446

(57) ABSTRACT

The present application relates to a method and an apparatus for determining a resource availability. One embodiment of the present disclosure provides a method for determining a resource availability, which includes: selecting a plurality of resources from a resource selection window; determining a sensing window based on the plurality of resources selected; and determining availability of the plurality of resources based on sensing result in the sensing window.

### TECHNICAL FIELD

The present disclosure relates to sidelink communication, and more specifically relates to determining a resource availability during sidelink communication.

### BACKGROUND OF THE INVENTION

In LTE V2X, partial sensing is introduced for the Pedestrian-UE (P-UE) to perform sensing with reduced power consumption. The resource reservation periods may include {100, 200, 300, ..., 1000 ms}, therefore, if intending to select a resource in subframe y, the P-UE may sense the availability of subframe y at the following times: {y-100, y-200, y-300, ..., y-1000ms}.

In NR (new radio) the resource reservation periods may include {0, 1:99, 100, 200, 300, 400, 500, 600, 700, 800, 900, 1000 ms}, the short resource reservation periods ranging from 1 to 99 are further included for urgent data transmissions.

Therefore, sensing the availability of subframe y only at the times of y-100, y-200, y-300, ..., y-1000ms may not be enough to avoid resource collision with other UEs, which utilize short resource reservation periods, such as Vehicle UE (V-UE).

### SUMMARY

It is desirable to provide a solution to avoid the resource collision.

One embodiment of the present disclosure provides a method for determining a resource availability, which includes: selecting a plurality of resources from a resource selection window; determining a sensing window based on the plurality of resources selected; and determining availability of the plurality of resources based on sensing result in the sensing window.

Another embodiment of the present disclosure provides an apparatus, which includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method for determining a resource availability, comprising: selecting a plurality of resources from a resource selection window; determining a sensing window based on the plurality of resources selected; and determining availability of the plurality of resources based on sensing result in the sensing window.

### BRIEF DESCRIPTION OF THE DRAWINGS

FIG. 1 illustrates a schematic diagram of a wireless communication system in accordance with some embodiments of the present disclosure.

FIG. 2 illustrates a solution for determining the resource availability.

FIG. 3 illustrates a solution for the resource selection according to some embodiments of the present disclosure.

FIG. 4 illustrates a solution for determining the resource availability according to some embodiments of the present disclosure.

FIG. 5 illustrates another solution for determining the resource availability according to some embodiments of the present disclosure.

FIG. 6 illustrates another solution for determining the resource availability according to some embodiments of the present disclosure.

FIG. 7 illustrates a method performed by a UE for wireless communication according to a preferred embodiment of the subject disclosure.

FIG. 8 illustrates a block diagram of a UE according to the embodiments of the subject disclosure.

### DETAILED DESCRIPTION

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

UE(s) under NR V2X scenario may be referred to as V2X UE(s). A V2X UE, which transmits data according to sidelink resource(s) scheduled by a base station (BS), may be referred to as a UE for transmitting, a transmitting UE, a transmitting V2X UE, a Tx UE, a V2X Tx UE, a SL Tx UE, or the like. A V2X UE, which receives data according to sidelink resource(s) scheduled by a BS, may be referred to as a UE for receiving, a receiving UE, a receiving V2X UE, a Rx UE, a V2X Rx UE, a SL Rx UE, or the like. The V2X UEs may include Pedestrian UE, which has limited power, and also include Vehicle UE, which does not have power limit.

V2X UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like.

According to some embodiments of the present application, V2X UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present application, V2X UE(s) includes wearable devices, such as smart watches, fitness bands, optical head-mounted displays, or the like. Moreover, V2X UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. V2X UE(s) may communicate directly with BS(s) via uplink (UL) communication signals.

A BS under NR V2X scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

A BS may serve a number of V2X UEs within a serving area, for example, a cell or a cell sector via a wireless communication link. A BS may communicate directly with one or more of V2X UEs via communication signals. For example, a BS may serve V2X UEs within a macro cell.

Sidelink communication between a Tx UE and a Rx UE under NR V2X scenario includes groupcast communication, unicast communication, or broadcast communication.

Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR, 3GPP LTE Release 12 and onwards, etc. It is contemplated that along with the 3GPP and related communication technology development, the terminologies recited in the present application may change, which should not affect the principle of the present application.

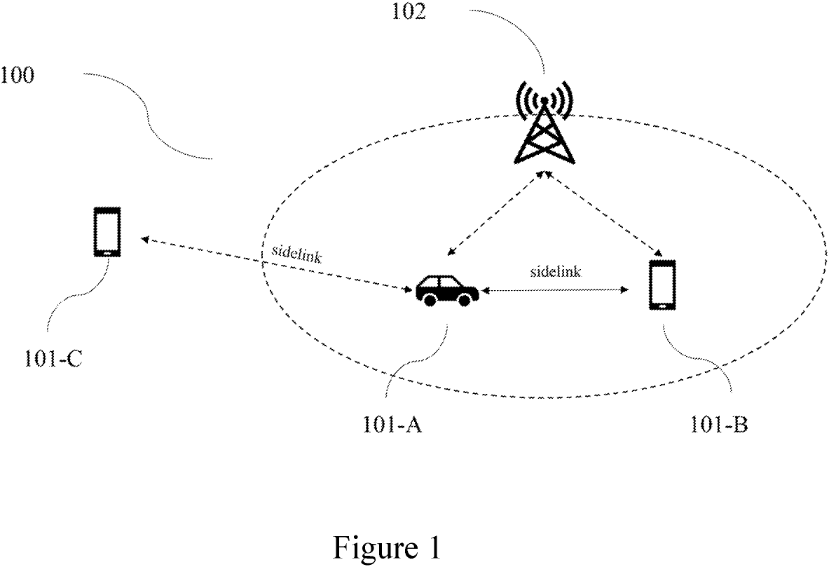

FIG. 1 illustrates an exemplary V2X communication system in accordance with some embodiments of the present application.

As shown in FIG. 1, the V2X communication system includes a base station, i.e., BS 102 and some V2X UEs, i.e., UE 101-A, UE 101-B, and UE 101-C. UE 101-A and UE 101-B are within the coverage of BS 102, and UE 101-C is not. UE-101-B and UE 101-C may be pedestrian UE, and UE 101-A may be a vehicle UE. UE 101-A and UE 101-B may perform sidelink unicast transmission, sidelink groupcast transmission, or sidelink broadcast transmission. It is contemplated that, in accordance with some other embodiments of the present application, a V2X communication system may include more or fewer BSs, and more or fewer V2X UEs. Moreover, it is contemplated that names of V2X UEs (which represent a Tx UE, a Rx UE, and etc.) as illustrated and shown in FIG. 1 may be different, e.g., UE 101c, UE 104f, and UE 108 g or the like.

In addition, although UE 101-A as shown in FIG. 1 is illustrated in the shape of a car, it is contemplated that a V2X communication system may include any type of UE (e.g., a roadmap device, a cell phone, a computer, a laptop, IoT (internet of things) device or other type of device) in accordance with some other embodiments of the present application.

According to some embodiments of FIG. 1, UE 101-A and UE 101-C function as Tx UE, and UE 101-B and UE 101-C function as a Rx UE. UE 101-A may exchange V2X messages with UE 101-B, or UE 101-C through a sidelink, for example, PC5 interface as defined in 3GPP documents. UE 101-A may transmit information or data to other UE(s) within the V2X communication system, through sidelink unicast, sidelink groupcast, or sidelink broadcast. For instance, UE 101-A transmits data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1, UE 101-B functions as a Tx UE and transmits V2X messages, UE 101-A functions as a Rx UE and receives the V2X messages from UE 101-B.

Both UE 101-A and UE 101-B in the embodiments of FIG. 1 may transmit information to BS 102 and receive control information from BS 102, for example, via NR Uu interface. BS 102 may define one or more cells, and each cell may have a coverage area. As shown in FIG. 1, both UE 101-A and UE 101-B are within the coverage of BS 102, and UE 101-C is outside of the coverage of BS 102.

BS 102 as illustrated and shown in FIG. 1 is not a specific base station, but may be any base station(s) in the V2X communication system. For example, if the V2X communication system includes two BSs 102, UE 101-A being within a coverage area of any one the two BSs 102 may be called as a case that UE 101-A is within a coverage of BS 102 in the V2X communication system; and only UE 101-A being outside of coverage area(s) of both BSs 102 can be called as a case that UE 101-A is outside of the coverage of BS 102 in the V2X communication system.

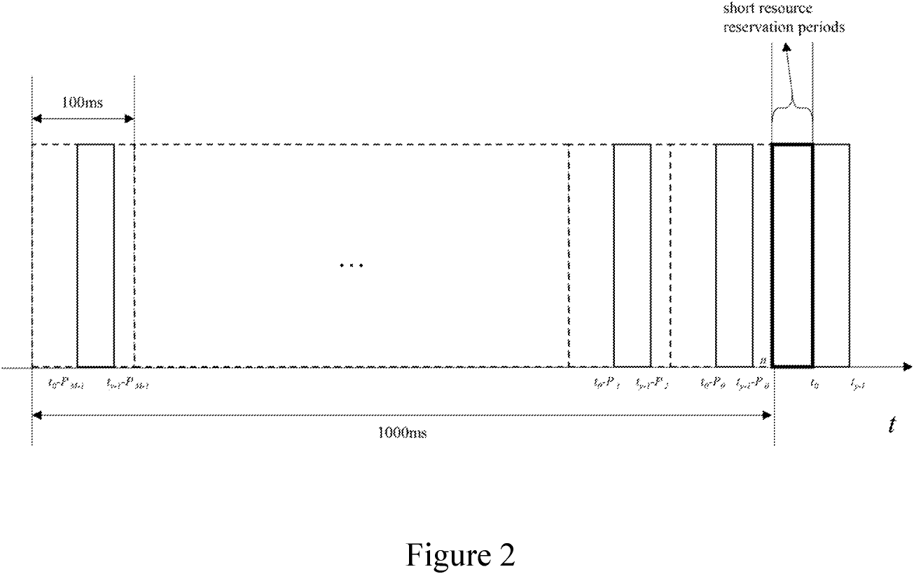

FIG. 2 illustrates a solution for determining the resource availability performed by a UE, such as a P-UE. As a resource selection is triggered at time n, the P-UE may select y subframes, where the first subframe of the y subframes is located at time t₀, the second at time t₁, and the last at time t_{y-1}.

In case M resource reservation periods of {Po, P₁, ..., P_{M-1}} of resource pool are configured,, the UE may perform sensing and measurement in subframe at the following time periods, t₀ - P₀, to t_{y-1} - P₀; t₀ - P₁, to t_{y-1} - P₁; ..., and t₀ - P_{M-1}, to t_{y-1} -P_{M-1}, so as to check the availability of the y subframes. The P-UE may not perform sensing between two time periods and in the interval ranges from the time n to the time t₀, for the sake of power saving

The value of the resource reservation periods P₀, P₁, ..., P_{M-1} might be selected from the group of 100, 200, 300, ..., and 1000 ms, and the size of partial sensing window is 1000 ms. Although the partial sensing is repeated with a period of 100 ms in this embodiment, the partial sensing may be repeated with other periods if the configured or preconfigured resource reservation periods change. The time period from n to t₀ may not be sensed.

In NR the resource reservation periods are configured from the set {0, [1:99], 100, 200, 300, 400, 500, 600, 700, 800, 900, 1000} ms. Other UEs, e.g., a V-UE, might be configured with a short resource reservation period, e.g., 5 ms. If the V-UE transmits a resource reservation request in the time period between n to t₀, to reserve the resource after 5 ms, the resource requested by the V-UE may overlap the y resources selected by the P-UE. If the P-UE does not perform sensing in the time period from n to t₀, the P-UE does not sense this reservation. Under this circumstance, resources collision might happen.

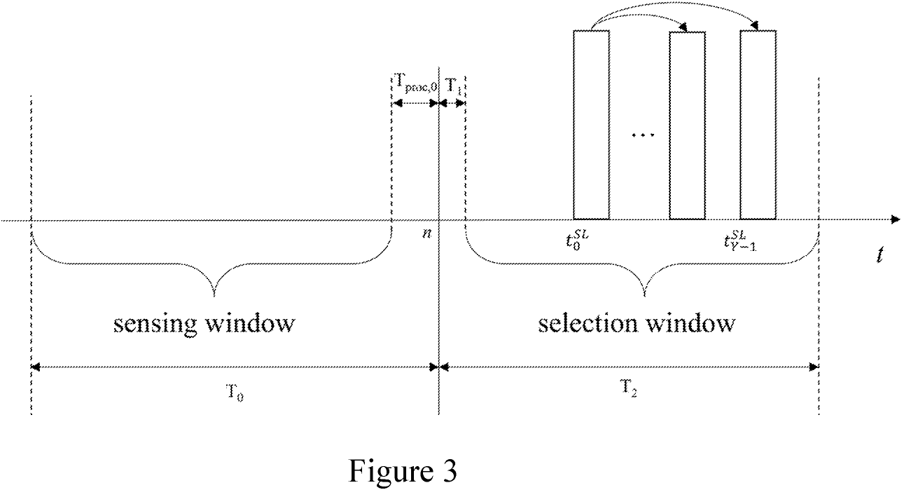

FIG. 3 illustrates a solution for the resource selection according to some embodiments of the present disclosure. In FIG. 3, T₀ is the size of the sensing window, which may be configured or pre-configured between two values: 100 ms and 1100 ms. The interval with a size of T_{proc,0} represents a time interval for processing information sensed in the sensing window, n represents the time when resource selection is triggered, T₁ represents the time interval for reporting sensed information to a higher layer and processing time of resource selection,

$${\text{t}}_{0}^{\text{SL}}$$

represents the time point when the plurality of resources start,

$${\text{t}}_{\text{Y} \text{−} \text{1}}^{\text{SL}}$$

represents the time point when the plurality of resources end, and T₂ is the size of the selection window. The resource at time

$${\text{t}}_{0}^{\text{SL}}$$

may further reserve the following resources.

When resource selection is triggered in time n, the UE shall determine the set of resources to be reported to higher layers for Physical Sidelink Shared Channel (PSSCH) transmission. In the time period from n-T₀ to n-T_{proc,0}, the UE would perform sensing. The value of

$${T}_{p r o c , 0}^{S L}$$

is defined in slots in Table 1 below, where µ_{SL} is the sub-carrier spacing (SCS) configuration of the sidelink bandwidth part (BWP). depending on sub-carrier spacing

TABLE 1

${T}_{p r o c , 0}^{S L} \text{depending on sub-carrier spacing}$

| µ_{SL} | ${T}_{p r o c , 0}^{S L} \text{[slots]}$ |
|---|---|
| 0 | 1 |
| 1 | 1 |
| 2 | 2 |
| 3 | 4 |

The size of T₁ is up to UE implementation under the condition that 0 ≤ T₁ ≤

$${T}_{p r o c , 1}^{S L} ,$$

where

$${T}_{p r o c , 1}^{S L}$$

is defined in slots in Table 2 below, and µ_{SL} is the SCS configuration of the BWP.

TABLE 2

${T}_{p r o c , 1}^{S L} \text{depending on sub-carrier spacing}$

| µ_{SL} | ${T}_{p r o c , 1}^{S L} \text{[slots]}$ |
|---|---|
| 0 | 3 |
| 1 | 5 |
| 2 | 9 |
| 3 | 17 |

The value of T₂ is determined based on T₂ₘᵢₙ and the remaining packet delay budget in slots, where T₂ₘᵢₙ is set to the corresponding value from higher layer parameter t2min SelectionWindow for the given value of L1 priority, prio_{TX}.

If T₂ₘᵢₙ is shorter than the remaining packet delay budget (in slots) then T₂ is up to UE implementation subject to T₂ₘᵢₙ ≤ T₂ ≤ remaining packet budget (in slots); otherwise T₂ is set to the remaining packet delay budget (in slots), that is, T₂ = remaining packet budget.

To sum up, the UE determines a set of resources, which are located at

$${t}_{0}^{S L} ,$$

$${t}_{1}^{S L} , … {t}_{Y - 1}^{S L} ,$$

in the selection window by its implementation, which is within the time interval [n+T₁,n+T₂]. The value of T₁ and T₂ are determined based on UE implementations under the conditions T₁ ≤ 4 and T₂ₘᵢₙ(prio_{TX}) ≤ T₂ ≤ 100, if T₂ₘᵢₙ(prio_{TX}) is provided by higher layers for prio_{TX}, otherwise 20 ≤ T₂ ≤ 100. The selected value of T₂ shall fulfil the latency requirement and the total number of resources, Y shall be greater than or equal to the high layer parameter of minimum candidate resources, minNumCandidateSF.

A set of possible resource reservation period is selected from a group including the values of: 0, [1:99], 100, 200, 300, 400, 500, 600, 700, 800, 900, 1000 ms. In the sidelink control information (SCI), less than or equal to 4 bits are used to indicate a period, and an actual set of values is configured or pre-configured.

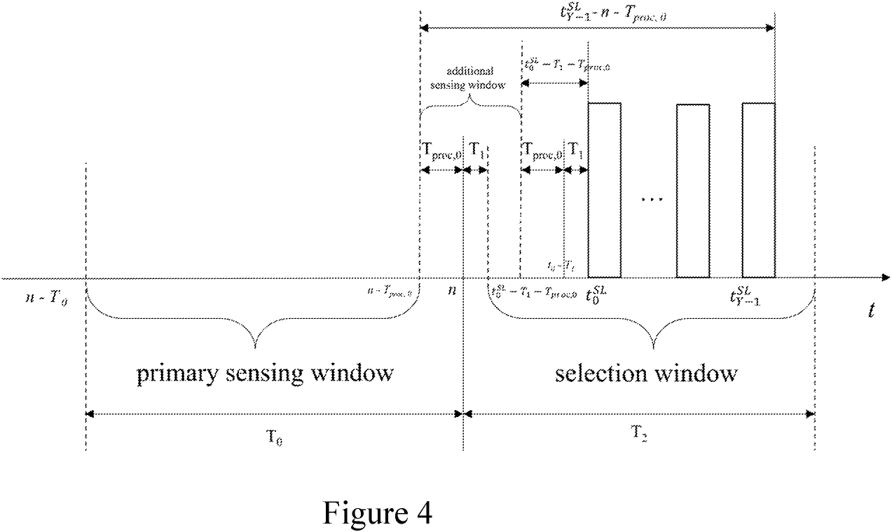

FIG. 4 illustrates a solution for determining the resource availability according to some embodiments of the present disclosure.

In FIG. 4, the UE is aware that a resource selection may be triggered at time n, then the UE selects a number of resources in the selection window. Each selected resource might be one slot, a plurality of contiguous slots, one sub-frame, a plurality of contiguous sub-frames, one sub-channel, a plurality of contiguous sub-channels, or the like. The total number of the resources is represented with Y, and these resources are located at time

$${t}_{0}^{S L} , {t}_{1}^{S L} , … , {t}_{Y - 1}^{S L}$$

respectively. The UE then determine the sensing window. The sensing window includes two parts, one is the primary sensing window, which ranges from the time n - T₀ to the time n - T_{proc,0}. T₀ may be preconfigured, and the time interval Tproc,₀ is the time required for the UE to process the sensed data. The other sensing window is an additional sensing window, which ranges from the time n - T_{proc,0} to the time

$${\text{t}}_{0}^{\text{SL}} - {T}_{1} - {T}_{p r o c , 0} .$$

The configured short reservation periods may be 1, 2, ..., or 99 ms. The UE may perform full sensing in the additional sensing window ranges from the time n - T_{proc,0} to the time

$${\text{t}}_{0}^{\text{SL}} - {T}_{1} - {T}_{p r o c , 0} .$$

That is, the UE senses in each resource in the additional sensing window ranges from the time n - T_{proc,0} to the time

$${\text{t}}_{0}^{\text{SL}} - {T}_{1} -$$

T_{proc,0}, so as to determine the availability of the selected resources at time

$${t}_{0}^{S L} , {t}_{1}^{S L} , … ,$$

$${t}_{Y - 1}^{S L} .$$

Alternatively, the UE may perform partial sensing in the additional sensing window based on the configured reservation periods. In the primary sensing window, the UE may perform full sensing, or partial sensing depending on the practical requirements.

The UE can determine whether to perform sensing in the additional sensing window based on the Y selected resources and the values of short resource reservation periods configured with the resource pool.

According to FIG. 4, if another UE reserves one of the Y selected resources in the additional sensing window, the largest resource reservation period should be less than or equal to the time of the last resource in the set of selected resources minus the starting time of the additional sensing window, which is represented as:

$${t}_{Y - 1}^{S L} - \left(n \text{-}\right)$$

T_{proc,0}), which equals to

$${t}_{Y - 1}^{S L} - n + {T}_{p r o c , 0.}$$

The smallest resource reservation period should be larger than or equal to the time of the first resource in the set of selected resources minus the ending time of the additional sensing window, which is represented as:

$${t}_{0}^{S L} - {T}_{1} - {T}_{p r o c , 0} .$$

In conclusion, when there is one resource reservation period in the resource reservation period set has a value ranges from

$${t}_{0}^{S L} - {T}_{1} - {T}_{p r o c , 0}$$

to

$${t}_{Y - 1}^{S L} - n + {T}_{p r o c ,}$$

₀, the UE needs to perform sensing in the additional sensing window, otherwise, the UE may not perform the sensing in the additional sensing window.

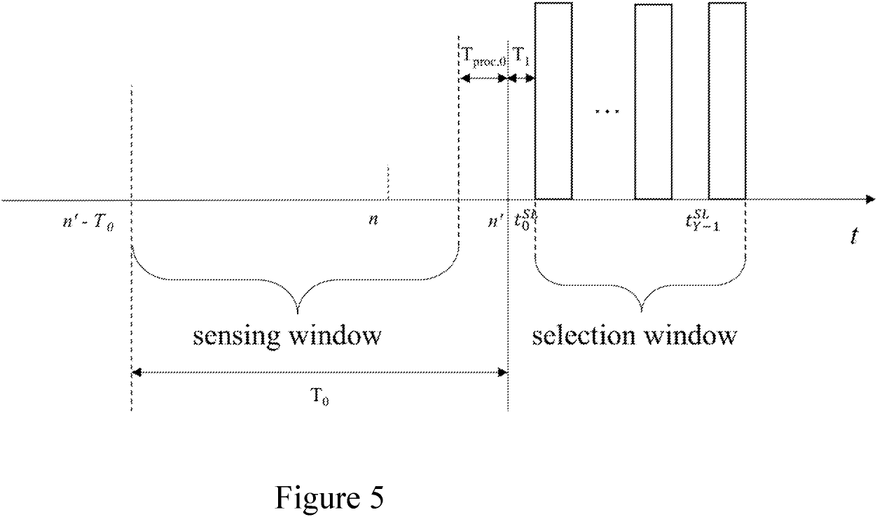

FIG. 5 illustrates another solution for determining the resource availability according to some embodiments of the present disclosure.

In FIG. 5, the UE is aware that a resource selection is triggered at time n, then the UE selects a number of resources in the selection window. The range of the sensing window is defined based on the Y selected slots. Each selected resource might be one slot, a plurality of contiguous slots, one sub-frame, a plurality of contiguous sub-frames, or the like. The total number of the resources is represented with Y, and these resources are located at time

$${t}_{0}^{S L} , {t}_{1}^{S L} , … , {t}_{Y - 1}^{S L}$$

respectively. The UE then determine that the sensing window ranges from

$${t}_{0}^{S L} - {T}_{1} - {T}_{0}$$

to

$${t}_{0}^{S L} - {T}_{1} - {T}_{p r o c , 0} .$$

Define

$${\text{n}}^{′} \text{=} {\text{t}}_{0}^{\text{SL}} - {T}_{1} ,$$

and the sensing window is defined by the range from n′ - T₀ to n′ -T_{proc,0}.

In FIG. 5, the UE performs sensing during the time interval from n′ - T₀ to n′ - T_{proc,0}, it can detects all the reserved resources before the first resource of the selected resources at time

$${t}_{0}^{S L} , {t}_{1}^{S L} , … , {t}_{Y - 1}^{S L} ,$$

compared with the sensing solution in FIG. 2, this solution can reduce the probability of resource collision if a transmission with short resource reservation happens in the interval from the time n to the time

$${t}_{0}^{S L} .$$

The higher layer may also trigger the UE to report the availability of the subset of resources at time

$${t}_{0}^{S L} , {t}_{1}^{S L} , … , {t}_{Y - 1}^{S L}$$

to higher layer for Physical Sidelink Control Channel (PSCCH) or PSSCH transmission. After receiving the trigger the UE should report the subset of resource during the time interval from n to n + Ti. In the solutions of FIGS. 4 and 5, the UE cannot determines the availability of the resource selected for PSCCH or PSSCH transmission until the time n′, which also is

$${\text{t}}_{0}^{\text{SL}} - {T}_{1} .$$

The UE may report the subset of resources to higher layer during the time interval from the time n′ to n′ + T₁.

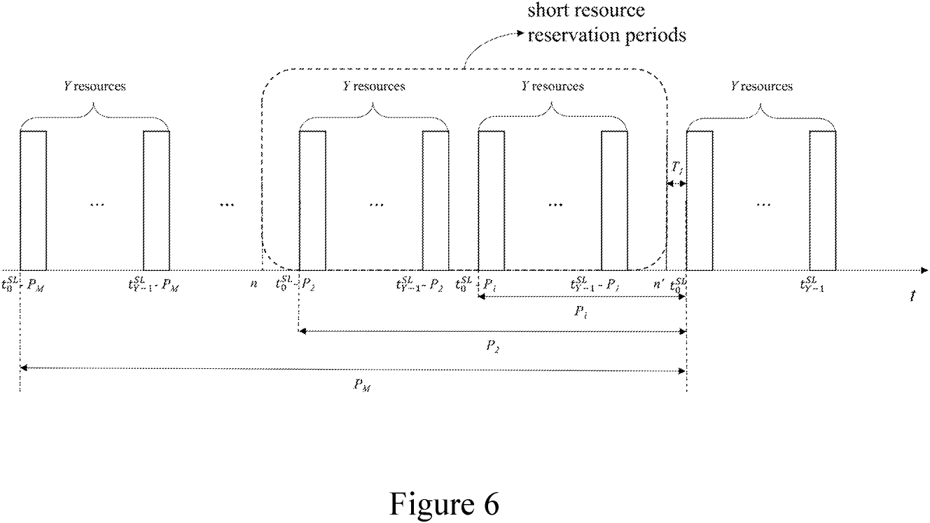

FIG. 6 illustrates another solution for determining the resource availability according to some embodiments of the present disclosure.

The actually sensing recourses are determined by the configured parameter, sl-ResourceReservePeriodList-r16, of the resource pool. There are up to 16 resource reservation periods can be configured from {0, 1:99, 100, 200, ..., 1000} ms. Assuming sl-ResourceReservePeriodList-r16 contains the values in the group of {0, P₁, P₂, ..., P_{M}}. For each resource located at the time of

$${\text{t}}_{\text{y}}^{S L} ,$$

in the selected Y resources, the UE should perform sensing in resource at the time of

$${\text{t}}_{\text{y}}^{S L} - {P}_{i}$$

to check whether the resource at time

$${\text{t}}_{\text{y}}^{S L}$$

could be the candidate resource for the UE, wherein i = 1, .. M.

For example, for the first resource in the Y resources, which located at time

$${\text{t}}_{\text{0}}^{S L} ,$$

the UE perform sensing in resource at times of

$${\text{t}}_{0}^{S L} - {P}_{1} , {\text{t}}_{0}^{S L} - {P}_{2} , … , {\text{t}}_{0}^{S L} - {P}_{M} .$$

Full sensing is not required in these embodiments.

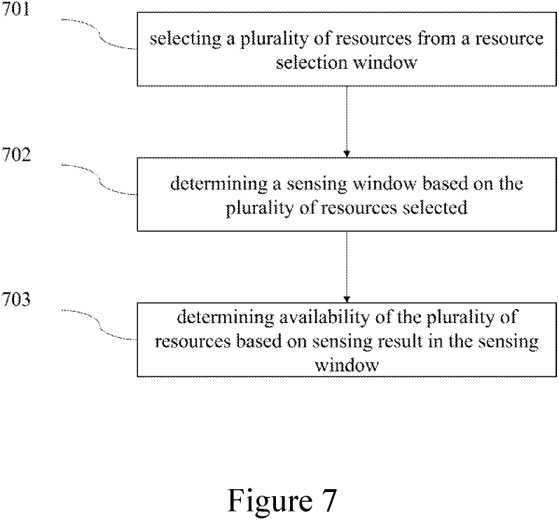

FIG. 7 illustrates a method performed by a UE for wireless communication according to a preferred embodiment of the subject disclosure.

In step 701, the UE selects a plurality of resources from a resource selection window, for example, in FIG. 4, the UE selects Y resources in the resource selection window. In step 702, the UE determines a sensing window based on the selected resources, for example, in FIG. 5, the UE determines the sensing window based on the Y selected resources. The UE then determines the availability of the plurality of resources based on sensing result in the sensing window.

In FIG. 4, the sensing window includes a primary sensing window and an additional sensing window. The UE may perform both partial sensing or full sensing in the two sensing windows. For example, the UE may perform partial sensing in the primary sensing window and full sensing in the additional sensing window; perform full sensing in the primary sensing window and partial sensing in the additional sensing window; perform full sensing in both sensing windows; or perform partial sensing in both sensing windows.

The additional sensing window is determined based on the selected resources and a set of resource reservation periods of a resource pool. More specifically speaking, the starting time of the second sensing window is determined based on the trigger of resource selection, namely, based on the time n in FIG. 4, and an ending time of the second sensing window is determined based on a starting time of the plurality of selected resources, that is, based on the starting time of the selected slots,

$${\text{t}}_{0}^{S L} ,$$

in FIG. 4. The starting time of the primary sensing window is determined based on a maximum value of the set of resource reservation periods, and an ending time of the primary sensing window is determined based on a trigger of resource selection. As shown in FIG. 4, the additional sensing window ranges from n-T_{proc,0} to

$${\text{t}}_{0}^{\text{SL}} -$$

T₁ - T_{proc,0}.

When there is no resource reservation request will be received in the additional sensing window depicted in FIG. 4, the UE can passing the sensing in the additional sensing window. If there is a value of one reservation period in the set of resource reservation periods ranges from

$${\text{t}}_{0}^{\text{SL}} - {T}_{1} - {T}_{p r o c , 0}$$

to

$${\text{t}}_{\text{Y} \text{−} \text{1}}^{\text{SL}} \text{-} n + {T}_{p r o c , 0} ,$$

the UE shall perform sensing in the additional sensing window. The availability of the y selected resources is determined after the additional sensing window and before the plurality of resources, for example, between the time

$${t}_{0}^{S L} - {T}_{1} - {T}_{p r o c , 0}$$

to the time

$${t}_{0}^{S L} - {T}_{1} .$$

The ending time of the sensing window is determined based on a starting time of the plurality of resources selected. For example, both the sensing windows in FIGS. 4 and 5 end at the time

$${t}_{0}^{S L} - {T}_{1} - {T}_{p r o c , 0} .$$

In FIG. 5, the sensing window ranges from

$${\text{t}}_{0}^{\text{SL}} - {T}_{1} - {\text{T}}_{0}$$

to

$${\text{t}}_{0}^{\text{SL}} - {T}_{1} - {T}_{p r o c , 0} .$$

The UE may further receives a set of resource reservation periods, for example, the parameter: sl-ResourceReservePeriodList-r16, and determines the availability of the plurality of resources by sensing in a plurality of time intervals, derived based on the set of resource reservation periods, when a resource reservation request may be received. For example, in FIG. 6, the UE performs sensing during the interval ranges from

$${t}_{0}^{S L} - {P}_{2}$$

to

$${\text{t}}_{\text{Y} \text{−} \text{1}}^{\text{SL}} - {P}_{2} .$$

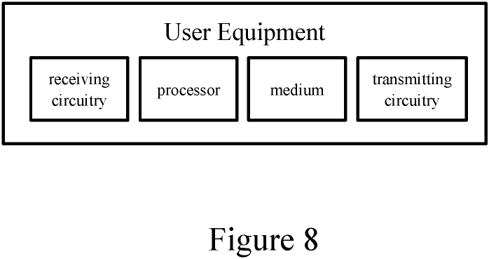

FIG. 8 illustrates a block diagram of a UE according to the embodiments of the subject disclosure. The UE may include a receiving circuitry, a processor, and a transmitting circuitry. In one embodiment, the UE may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g. the methods in FIG. 4) with the receiving circuitry, the transmitting circuitry and the processor. That is, the processor may select a plurality of resources from a resource selection window; determine a sensing window based on the plurality of resources selected; and determine availability of the plurality of resources based on sensing result in the sensing window.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method for determining a resource availability, the method comprising:
selecting a plurality of resources from a resource selection window;
determining a sensing window based on the plurality of resources selected; and
determining availability of the plurality of resources based on a sensing result in the sensing window.

2. The method of claim 1, wherein the sensing window comprises a first sensing window for partial sensing and a second sensing window for full sensing.

3. The method of claim 1, wherein the sensing window comprises a first sensing window and a second sensing window both for full sensing.

4. The method of claim 1, wherein the sensing window comprises a first sensing window and a second sensing window both for partial sensing.

5. The method of claim 2, wherein the second sensing window is determined based on the plurality of resources selected and a set of resource reservation periods of a resource pool.

6. The method of claim 5, wherein a starting time of the first sensing window is determined based on a maximum value of the set of resource reservation periods, and an ending time of the first sensing window is determined based on a trigger of resource selection.

7. The method of claim 5, wherein a starting time of the second sensing window is determined based on the trigger of resource selection, and an ending time of the second sensing window is determined based on a starting time of the plurality of selected resources.

8. The method of claim 7, wherein the second sensing window ranges from n-T_{proc},₀ to
$${\text{t}}_{0}^{\text{SL}} - {T}_{1} - {T}_{p r o c , 0} ,$$
wherein n represents a first time point when resource selection is triggered,
$${\text{t}}_{0}^{\text{SL}}$$
represents a second time point when the plurality of resources start, T_{proc},₀ represents a first time interval for processing information sensed in the first sensing window, and T₁ represents a second time interval for reporting sensed information to a higher layer and processing time of resource selection.

9. The method of claim 5, wherein sensing in the second sensing window can be omitted if it is determined, based on the set of resource reservation periods, that no resource reservation request will be received in the second sensing window.

10. The method of claim 5, wherein sensing in the second sensing window is not omitted if a value of one resource reservation period in the set of resource reservation periods ranges from
$${\text{t}}_{0}^{\text{SL}} - {T}_{1} - {T}_{p r o c , 0} \text{to} {\text{t}}_{\text{Y} - 1}^{\text{SL}} \text{-} n + {T}_{p r o c , 0} ,$$
wherein
$${\text{t}}_{0}^{\text{SL}}$$
represents a first time point when the plurality of resources start, T_{proc},₀ represents a first time interval for processing information sensed in the first sensing window, and T₁ represents a second time interval for reporting sensed information to a higher layer and processing time of resource selection, and
$${\text{t}}_{\text{Y} - 1}^{\text{SL}}$$
represents a second time point when the plurality of resources end.

11. The method of claim 2, wherein the availability of the plurality of resources is determined after the second sensing window and before the plurality of resources.

12. The method of claim 1, wherein an ending time of the sensing window is determined based on a starting time of the plurality of resources selected.

13. The method of claim 12, wherein the sensing window ranges from
$${\text{t}}_{0}^{\text{SL}} - {T}_{1} - {\text{T}}_{0} \text{to} {\text{t}}_{0}^{\text{SL}} - {T}_{1} - {T}_{p r o c , 0} ,$$
wherein
$${\text{t}}_{0}^{\text{SL}}$$
represents a second time point when the plurality of resources start, T_{proc},₀ represents a first time interval for processing information sensed in the sensing window, T₁ represents a second time interval for reporting sensed information to a higher layer and processing time of resource selection, and T₀ represents a predetermined period for sensing window.

14. The method of claim 1, further comprising:
receiving a set of resource reservation periods; and
determining availability of the plurality of resources by sensing in a plurality of time intervals, derived based on the set of resource reservation periods, when a resource reservation request may be received.

15. An apparatus, comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry,
wherein the computer-executable instructions cause the processor to implement a method for determining a resource availability, the method comprising:
selecting a plurality of resources from a resource selection window;
determining a sensing window based on the plurality of resources selected; and
determining availability of the plurality of resources based on a sensing result in the sensing window.

16. The apparatus of claim 15, wherein the sensing window comprises a first sensing window for partial sensing and a second sensing window for full sensing.

17. The apparatus of claim 15, wherein the sensing window comprises a first sensing window and a second sensing window both for full sensing.

18. The apparatus of claim 15, wherein the sensing window comprises a first sensing window and a second sensing window both for partial sensing.

19. The apparatus of claim 15, wherein an ending time of the sensing window is determined based on a starting time of the plurality of resources selected.

20. The apparatus of claim 15, further comprising:
receiving a set of resource reservation periods; and
determining availability of the plurality of resources by sensing in a plurality of time intervals, derived based on the set of resource reservation periods, when a resource reservation request may be received.
